(19) United States
(12) Patent Application Publication
(10) Pub. No.: US 2008/0186643 A1
(43) Pub. Date: Aug. 7, 2008

(54) Voltage surge protection device with a movable contact comprising selective disconnection means against short-circuits

(75) Inventor: Eric Domejean, Voreppe (FR)

Correspondence Address: STEPTOE & JOHNSON LLP, 1330 CONNECTICUT AVENUE, N.W., WASHINGTON, DC, 20036, US

(73) Assignee: Schneider Electric Industries SAS, Rueil Malmaison (FR)

(21) Appl. No.: 12/007,659

(22) Filed: Jan. 14, 2008

(30) Foreign Application Priority Data
Feb. 1, 2007 (FR) 07 00708

(51) Int. Cl. H02H 9/04

(52) U.S. Cl. 361/56

(57) ABSTRACT

A voltage surge protection device comprises a voltage surge limiter and a disconnecting device with electric contacts. Said disconnecting device comprises a first connecting electrode electrically connected with a first connecting pad, a second connecting electrode electrically connected with a second connecting pad, and a third switching electrode electrically connected to the second connecting pad. An actuating mechanism moves the third electrode to cause continuous opening of the electric contacts. The protection device comprises a disconnector against short-circuit currents connected in series between the third electrode and the second connecting pad Said disconnector is disconnected from the circuit when an electric arc is switched between the first connecting electrode and the second connecting electrode.

### BACKGROUND OF THE INVENTION

The invention relates to a voltage surge protection device comprising a voltage surge limiter with non-linear elements variable with the voltage and a disconnecting device with electric contacts electrically arranged in series with the voltage surge limiter. Said disconnecting device comprises a first connecting electrode electrically connected with a first connection pad, a second connecting electrode electrically connected with a second connection pad, and a third movable arc switching electrode electrically connected to the second connection pad. An actuating mechanism moves the third movable arc switching electrode to cause continuous opening of the electric contacts when electric currents having a greater energy than a tripping threshold energy flow through the protection device.

### STATE OF THE PRIOR ART

Voltage surge protection devices are known comprising a voltage surge limiter with non-linear elements variable with the voltage and a disconnecting device with contacts actuated by an actuating mechanism. The voltage surge limiter and disconnecting device are connected in series.

As described in the document EP0441722B1, the disconnecting device with contacts can take a tripped position and a make position respectively corresponding to the open state and the closed state of the contacts. An actuating mechanism makes the contacts of the disconnecting device move to the open state in particular in the event of the voltage surge limiter being destroyed when said non-linear elements are at the end of life.

The disconnecting device with contacts is calibrated:
on the one hand to enable lightning wave electric currents of 10/350 or 8/20 type to flow without the actuating mechanism being actuated, and
on the other hand to actuate the actuating mechanism and cause continuous opening of the contacts for short-circuit alternating currents.

The contacts can generally open (repulse) and close under a lightning stroke without the actuating mechanism unlatching. These repulsions (openings) of the contacts during operation of the protection device are followed by automatic re-closing of said contacts. What is then meant by “continuous opening” of the contacts is opening caused by the actuating mechanism. Re-closing of the contacts is only possible by a deliberate external action by a user.

Calibration of known protection devices is in fact performed in such a way that the actuating mechanism of the disconnecting device remains latched in the presence of electric lightning wave currents of 10/350 or 8/20 type. It is generally not desirable for the actuating mechanism of the disconnecting device to unlatch and cause continuous opening of the contacts each time an electric lightning wave current flows through the latter.

The tripping energy threshold is directly dependent on the electric lightning wave currents of 10/350 or 8/20 type for which opening of the contacts of the disconnecting device is not desired.

Short-circuit alternating currents having a greater electric energy than the tripping threshold energy cause the disconnecting device contacts to open.

For electric lightning wave currents of 10/350 or 8/20 type having a lower energy than the tripping threshold energy, the protection device is efficient and enables electric lightning wave currents to flow without their energy being responsible for material damage. Moreover, 10/350 or 8/20 electric lightning wave currents having a lower energy than the “tripping threshold energy” do not unlatch the actuating mechanism of the disconnecting device to cause opening of the contacts.

However, under certain particular circumstances, known protection devices do not present the sufficient level of protection.

Indeed, when the energy of short-circuit alternating currents becomes lower than that of the tripping threshold energy, the actuating mechanism is no longer actuated and does not cause the disconnecting device contacts to move from the closed state to the open state. The risk of the components being damaged is then not negligible.

This situation can in particular arise when:
the impedance of the voltage surge limiter becomes weak after receiving numerous lightning strokes. A “weak short-circuit alternating current” having a lower energy than that of the tripping threshold energy then flows in the protection device.
incorrect fitting of the protection device is performed, in particular, when a protection device, usually connected between a phase and neutral, is connected for example between two phases. The voltage applied between phases is generally higher than that which the voltage surge limiter can withstand continuously. The voltage surge limiter then turns on and a “weak short-circuit alternating current” flows in the protection device. This weak short-circuit alternating current can be reduced if the supply transformer energy is low and/or when the cable lengths are great.

In both the situations described above, the reduced short-circuit current having a lower energy than that of the tripping threshold energy can result in material damage.

### SUMMARY OF THE INVENTION

The object of the invention is therefore to remedy the shortcomings of the state of the technique so as to propose a voltage surge protection device comprising disconnection means that are efficient against short-circuits.

The voltage surge protection device according to the invention comprises a disconnector against weak short-circuit alternating currents connected in series between the third movable arc switching electrode and the second connecting pad. Said disconnector is disconnected from the circuit when an electric arc is switched between the first connecting electrode and the second connecting electrode, and said disconnector switches from a closed electric state to an open electric state when electric short-circuit alternating currents having a lower energy than the tripping threshold energy flow through the latter.

Advantageously, the disconnector against weak electric short-circuit alternating currents is a thermal disconnector.

Preferably, the thermal disconnector is a protective fuse.

According to a preferred embodiment of the invention, the voltage surge limiter is connected in series with the disconnector against weak short-circuit alternating currents between the movable arc switching electrode and the second connecting pad, said limiter and said disconnector being simultaneously disconnected from the circuit when an electric arc is switched between the first connecting electrode and the second connecting electrode.

According to a preferred embodiment of the invention, the voltage surge limiter is electrically connected in series with the disconnecting device by at least one fuse link, drive means exert a displacement force displacing the voltage surge limiter in case of melting of said at least one fuse link, displacement of said limiter acting directly on the actuating mechanism to move the third movable arc switching electrode and causing continuous opening of the contacts.

Advantageously, the drive means comprise a spring.

In a particular embodiment, the voltage surge limiter is electrically connected to the second connecting pad by two fuse links, a first fuse link acting as disconnector against weak short-circuit alternating currents, and a second fuse link that melts in case of overheating of said limiter.

Preferably, the second fuse link is a low-temperature weld.

Preferably, the surge voltage limiter comprises a variable resistor.

Preferably, the surge voltage limiter comprises a variable resistor connected in series with a spark gap.

In a particular embodiment, a high-energy disconnector is connected in series between the first connecting electrode and the first connecting pad, said high-energy disconnector acting on the actuating mechanism to move the third movable arc switching electrode and cause continuous opening of the electric contacts.

Preferably, the high-energy disconnector is calibrated to act on the actuating mechanism when electric currents having a greater energy than the tripping threshold energy flow through the latter.

Advantageously, the high-energy disconnector comprises electromagnetic tripping means.

Advantageously, the high-energy disconnector comprises a fuse element.

Preferably, the third movable arc switching electrode is connected to the first connecting electrode by an insulating part forming a spark gap when the electric contacts are closed.

Advantageously, the third movable arc switching electrode is in contact with the first connecting electrode when the electric contacts are closed.

Advantageously, the disconnector against weak short-circuit alternating currents is disconnected from the circuit when the third movable arc switching electrode moves away from the first connecting electrode and an electric arc is switched between the first connecting electrode and the second connecting electrode.

### BRIEF DESCRIPTION OF THE DRAWINGS

Other advantages and features will become more clearly apparent from the following description of particular embodiments of the invention, given as non-restrictive examples only, and represented in the accompanying drawings in which:

FIG. 1 represents a protection device according to a first preferred embodiment of the invention in the closed position;

FIG. 2 represents a protection device according to FIG. 1 in the course of opening;

FIG. 3 represents a protection device according to FIG. 1 in the open position;

FIG. 4 represents a protection device according to a second preferred embodiment of the invention in the closed position;

FIG. 5 represents a protection device according to FIG. 4 in the course of opening;

FIG. 6 represents a protection device according to FIG. 4 in the open position;

FIGS. 7 to 9 represent a first alternative embodiment of the protection device according to the different embodiments of the invention;

FIGS. 10 to 11 represent schematic view of alternatives embodiment of the protection device according to the different embodiments of the invention.

### DETAILED DESCRIPTION OF AN EMBODIMENT

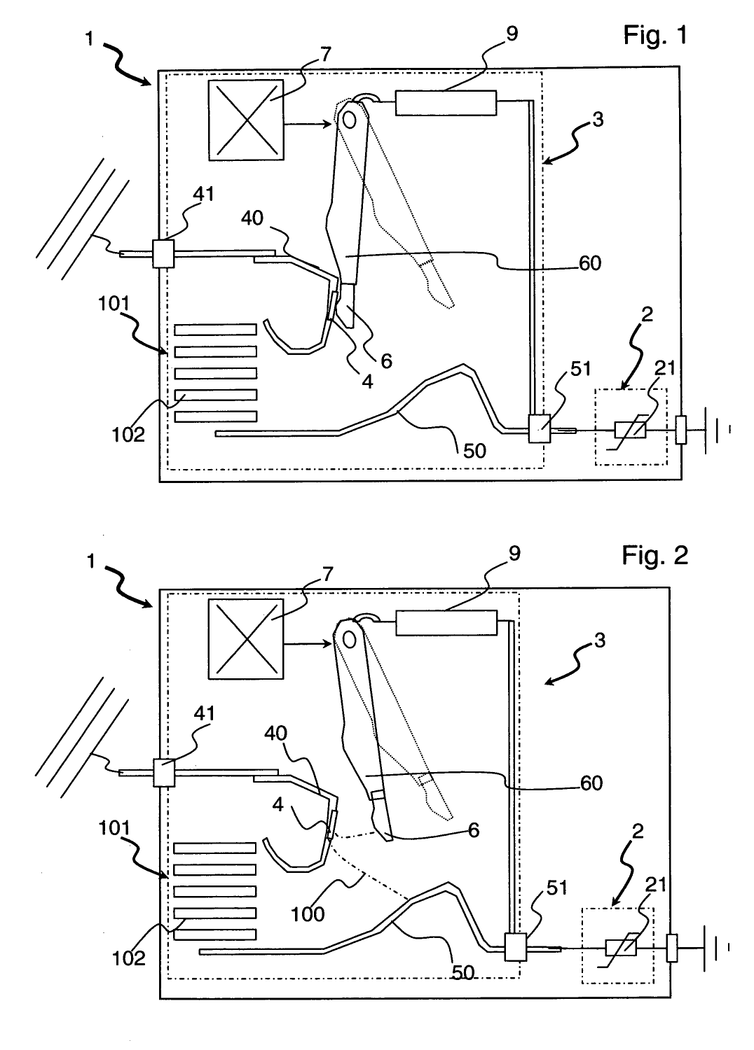

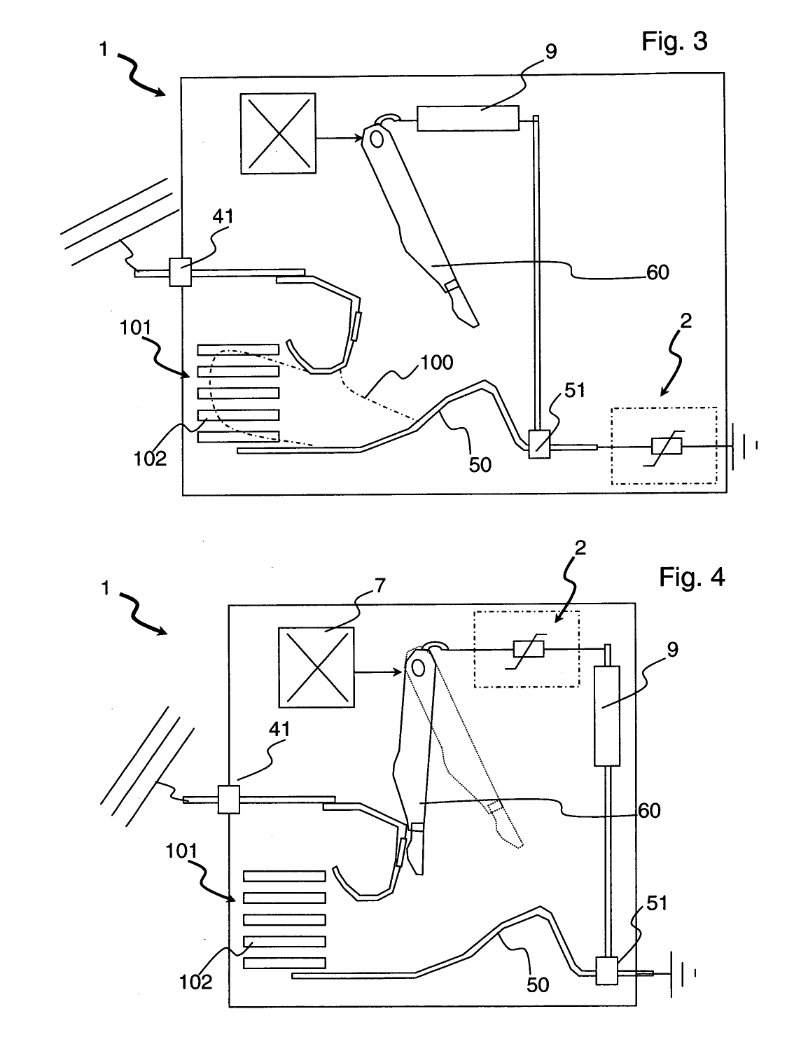

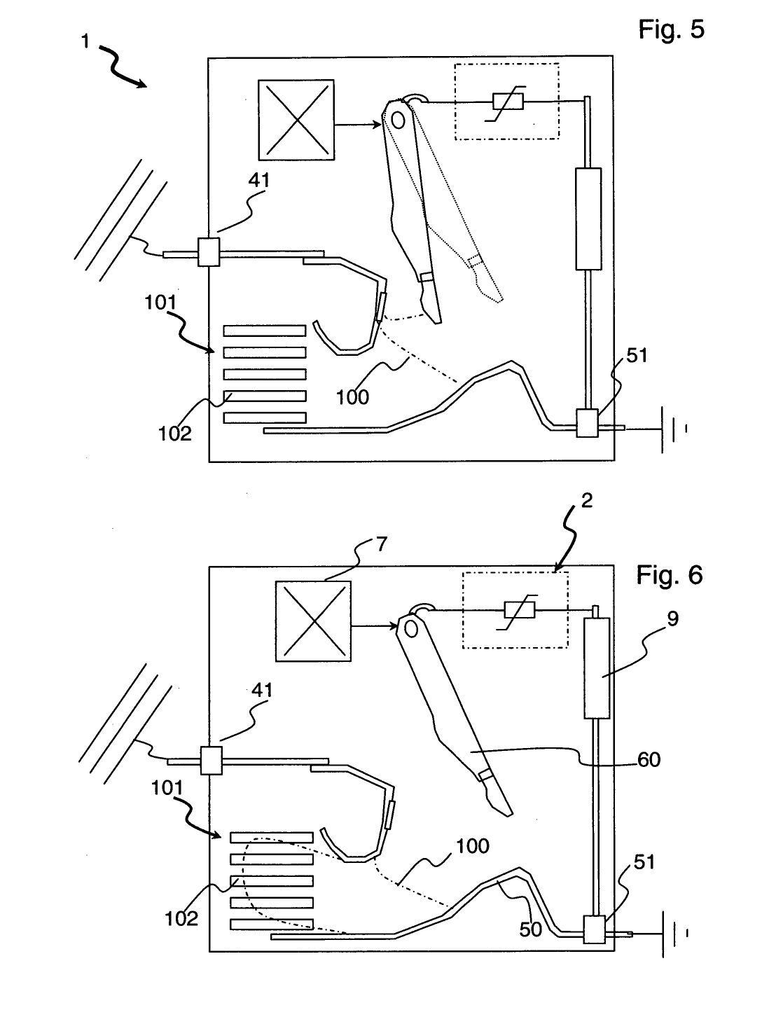

As represented in FIGS. 1 to 6, voltage surge protection device 1 comprises a voltage surge limiter 2 with non-linear elements variable with the voltage and a disconnecting device 3 with electric contacts 4, 6. Voltage surge limiter 2 and disconnecting device 3 are electrically connected in series.

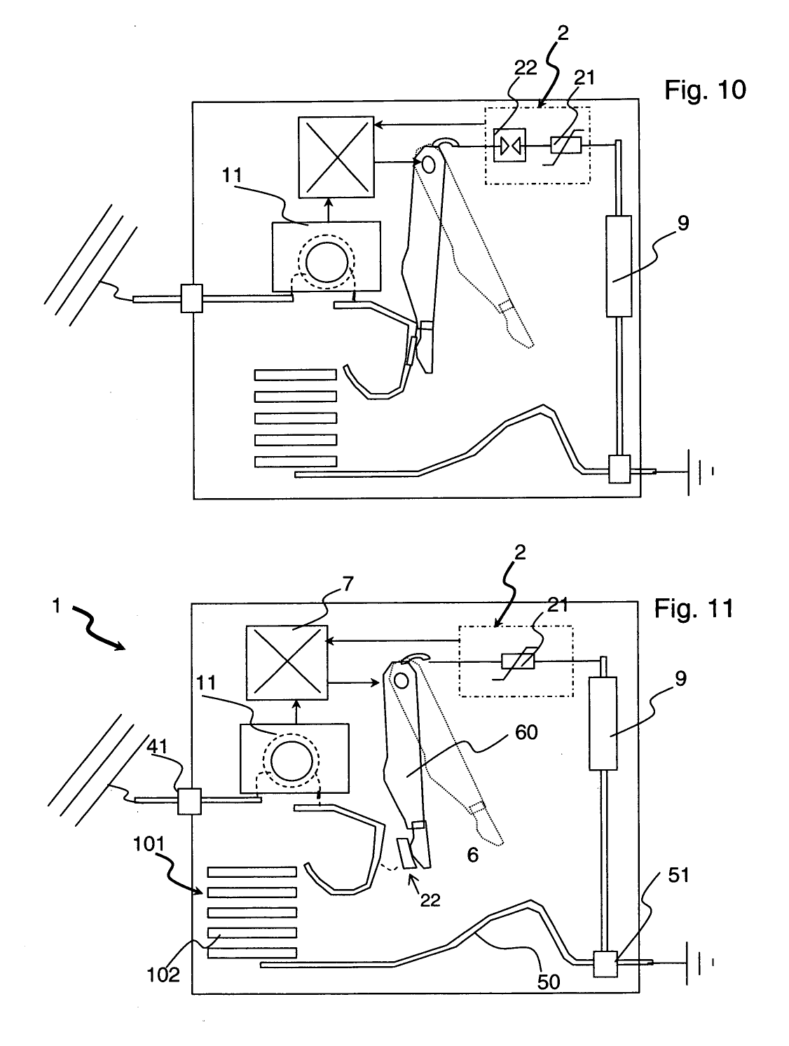

Voltage surge limiter 2 preferably comprises a variable resistor 21. In certain embodiments of the invention as represented in FIGS. 10 and 11, a spark gap 22 can also be placed in series with variable resistor 21.

Disconnecting device 3 comprises a first connecting electrode 40 electrically connected with a first connecting pad 41 and a second connecting electrode 50 electrically connected with a second connecting pad 51.

If protection device 1 is connected between phase and neutral, connecting pads 41, 51 are designed to be respectively connected to a phase and to neutral or vice-versa.

If protection device 1 is connected between phase and earth, connecting pads 41, 51 are designed to be respectively connected to a phase and to earth or vice-versa.

Disconnecting device 3 comprises a third movable arc switching electrode 60 electrically connected to second connecting pad 51.

A first electric contact 4 is placed on first connecting electrode 40 and a second electric contact 6 is positioned on third movable arc switching electrode 60.

According to one embodiment as represented in FIGS. 1 to 6, third movable arc switching electrode 60 is in contact with first connecting electrode 40 when electric contacts 4, 6 are closed.

Disconnecting device 3 further comprises an actuating mechanism 7. Said mechanism is designed to be actuated to move third movable arc switching electrode 60 and mechanically cause continuous opening of electric contacts 4, 6.

Disconnecting device 3 with contacts 4, 6 is calibrated on the one hand to enable lightning wave electric currents of 10/350 or 8/20 type to flow without actuating mechanism 7 being actuated, and on the other hand to actuate actuating mechanism 7 and cause continuous opening of contacts 4, 6 for short-circuit alternating currents.

Calibration of protection devices 1 is performed in such a way that actuating mechanism 7 of disconnecting device 3 remains latched in the presence of lightning wave electric currents of 10/350 or 8/20 type. Actuating mechanism 7 does not in fact cause continuous opening of the contacts each time a lightning wave electric current flows through the latter.

The tripping energy threshold is directly dependent on the lightning wave electric currents of 10/350 or 8/20 type for which opening of contacts 4, 6 of disconnecting device 3 is not desired.

When electric currents having a greater energy than the tripping energy threshold flow through the protection device, actuating mechanism 7 is actuated and moves third movable arc switching electrode 60 and mechanically causes continuous opening of electric contacts 4, 6. The electric currents responsible for actuation of actuating mechanism 7 are generally short-circuit alternating currents.

When lightning wave electric currents of 10/350 or 8/20 type having a lower energy than the tripping energy threshold flow through the protection device, the protection device is efficient and enables lightning wave electric currents to flow without their energy being responsible for material damage. Moreover, said lightning wave electric currents do not unlatch the actuating mechanism of the disconnecting device to cause opening of the contacts.

The voltage surge protection device comprises a disconnector against weak short-circuit alternating currents 9.

As represented in FIGS. 1 to 6, according to all the preferred embodiments, the disconnector against weak short-circuit alternating currents 9 is connected in series between third movable arc switching electrode 60 and second connecting pad 51.

When lightning wave electric currents of 10/350 or 8/20 type flow through the protection device, an electric arc 100 is very quickly switched between first connecting electrode 40 and second connecting electrode 50. Disconnector against weak short-circuit alternating currents 9 is disconnected from the circuit and the lightning wave does not flow through the latter. Disconnector against weak short-circuit alternating currents 9 is then protected and is not damaged by lightning strokes.

The protection device comprises an arc chute 101. First connecting electrode 40 and second connecting electrode 50 are arranged facing arc chute 101 and delineate the opening of said arc chute 101. Said arc chute 101 comprises deionization fins 102 designed for cooling an electric arc 100 and for extinguishing same.

When weak short-circuit alternating currents having a lower energy than the tripping threshold energy flow through the protection device, said currents flow through the first connecting electrode 40, third movable arc switching electrode 60 and disconnector against weak short-circuit alternating currents 9. Said disconnector is calibrated to then switch from a closed electric state to an open electric state.

Disconnector against weak short-circuit alternating currents 9 can be a thermal disconnector. Disconnector against weak short-circuit alternating currents 9 is preferably a protective fuse.

According to a second embodiment of the invention as represented in FIGS. 4 to 6, voltage surge limiter 2 is electrically connected in series with disconnector against weak short-circuit alternating currents 9 between movable arc switching electrode 60 and second connecting pad 51.

Thus, when lightning wave electric currents of 10/350 or 8/20 type flow through the protection device, an electric arc 100 is very quickly switched between first connecting electrode 40 and second connecting electrode 50, and voltage surge limiter 2 and disconnector against weak short-circuit alternating currents 9 are simultaneously disconnected from the circuit and the lightning wave does not flow through the latter. Said limiter and said disconnector are then protected and are not damaged by lightning strokes.

According to a first alternative embodiment, voltage surge limiter 2 is electrically connected in series with disconnecting device 3 by at least one fuse link 9, 8. Drive means 10 continuously exert a displacement force Fd on said voltage surge limiter. If at least one of the fuse links is destroyed, voltage surge limiter 2 then moves due to the action of displacement force Fd. Movement of said limiter acts directly on actuating mechanism 7. Said mechanism unlatches and moves third movable arc switching electrode 60 causing continuous opening of contacts 4, 6.

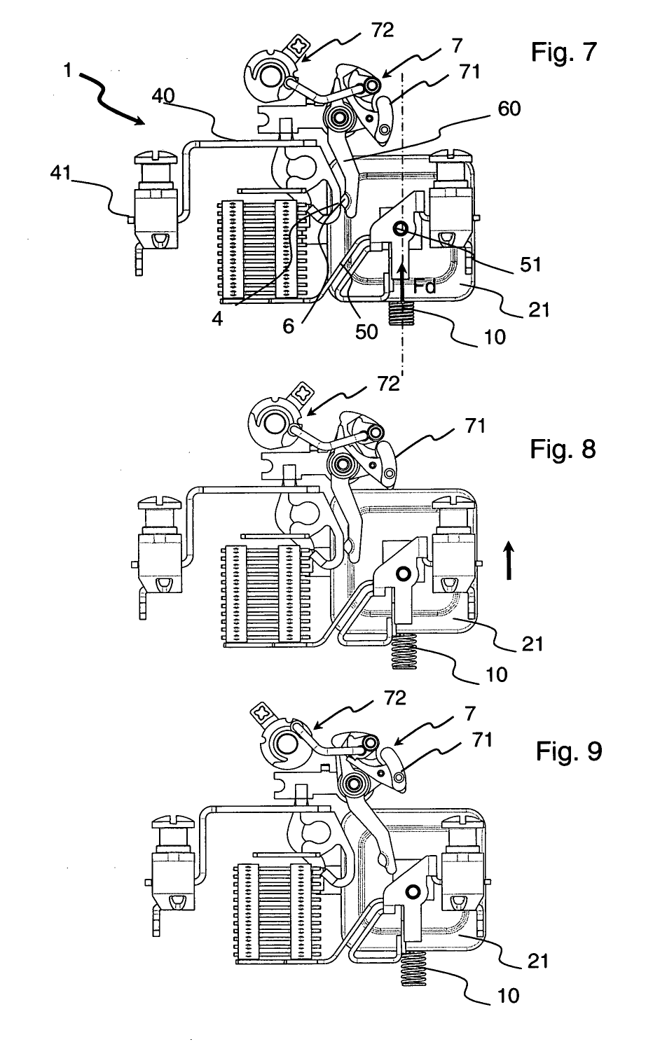

As represented in FIGS. 7 to 9, drive means 10 preferably comprise a spring. This spring, which is a coiled spring, is compressed and exerts displacement force Fd directly on variable resistor 21. According to this particular embodiment of the alternative version, variable resistor 21 is connected in series with disconnecting device 3 by means of two connection terminals.

A first connection terminal is connected to disconnecting device 3 by a flexible metal braid (not represented), and a second connection terminal is connected to second connecting pad 51 by a rigid pin integrating said at least one fuse link.

As represented in FIG. 7, the rigid pin keeps the variable resistor in a first position. The third movable arc switching electrode is in a position called the service position. When at least one of the fuse links melts, the rigid pin breaks and releases movement of the variable resistor due to the action of displacement force Fd. As represented in FIG. 8, variable resistor 21 moves to act directly on actuating mechanism 7. Indeed, as represented in FIGS. 8 and 9, variable resistor 21 comes into contact with a trip bar 71 of actuating mechanism 7 which unlatches to move third movable arc switching electrode 60. Movement of said third electrode causes continuous opening of contacts 4, 6. Third movable arc switching electrode 60 is then in a position called the switching position.

Voltage surge limiter 2 can be electrically connected to second connecting pad 51 by two fuse links 9, 8.

A first fuse link acts as against disconnector against weak short-circuit alternating currents. According to the embodiment as represented in FIGS. 7 to 9, the rigid pin connecting the variable resistor to second connecting pad 51 then comprises a section that is calibrated so as to melt when electric short-circuit currents of lower energy than the tripping threshold flow through said pin.

A second fuse link 8 melts in the event of overheating of said limiter. According to the embodiment as represented in FIGS. 7 to 9, the rigid pin connecting the variable resistor to second connecting pad 51 is welded to the second terminal of the variable resistor by a low-temperature weld.

Operation of the first alternative embodiment remains unchanged if variable resistor 21 is placed in a carriage or in a movable casing forming a single block with variable resistor 21. The displacement force could then be applied to the carriage or movable casing instead of being applied directly to the variable resistor. Moreover, the carriage or movable casing could act directly on trip bar 71 of actuating mechanism 7.

According to a first alternative embodiment as represented in FIG. 10, a high-energy disconnector 11 is connected in series between first connecting electrode 40 and first connecting pad 41. Said high-energy disconnector is designed to act on actuating mechanism 7 to move third movable arc switching electrode 60 and cause continuous opening of electric contacts 4, 6. High-energy disconnector 11 is calibrated to unlatch actuating mechanism 7 when electric currents of greater energy than the tripping threshold energy flow through the latter.

According to a particular embodiment, high-energy disconnector 11 comprises electromagnetic tripping means or a fuse element.

According to a third alternative embodiment of the different embodiments of the invention, as represented in FIG. 11, third movable arc switching electrode 60 is connected to first connecting electrode 40 by an insulating part when electric contacts 4, 6 are closed. The insulating part forms a spark gap 22 electrically positioned in series with variable resistor 21 of voltage surge limiter 2. In the event of a lightning stroke, disconnector against weak short-circuit alternating currents 9 is disconnected from the circuit when an electric arc 100 is switched between first connecting electrode 40 and second connecting electrode 50.

According to another alternative embodiment, the disconnecting device comprises resetting means 72. Resetting means 72 enable said third electrode to move from the position called switching position to the position called service position. In other words, closing of contacts 4, 6 can be brought about mechanically by means of resetting means 72 after continuous opening of said contacts.

1. A voltage surge protection device comprising:
a voltage surge limiter with non-linear elements variable with the voltage,
a disconnecting device with electric contacts electrically arranged in series with the voltage surge limiter said disconnecting device comprising:
a first connecting electrode electrically connected with a first connecting pad,
a second connecting electrode electrically connected with a second connecting pad,
a third movable arc switching electrode electrically connected with the second connecting pad,
an actuating mechanism moving the third movable arc switching electrode to cause continuous opening of the electric contacts when electric currents of higher energy than a tripping threshold energy flow through the protection device,
comprising a disconnector against weak short-circuit alternating currents connected in series between the third movable arc switching electrode and the second connecting pad,
said disconnector being disconnected from the circuit when an electric arc is switched between the first connecting electrode and the second connecting electrode,
said disconnector switching from a closed electric state to an open electric state when short-circuit electric alternating currents having a lower energy than the tripping threshold energy flow through the latter.

2. The device according to claim 1, wherein the disconnector against weak short-circuit alternating currents is a thermal disconnector.

3. The device according to claim 2, wherein the disconnector against weak short-circuit alternating currents is a protective fuse.

4. The device according to claim 1, wherein the voltage surge limiter is connected in series with the disconnector against weak short-circuit alternating currents between the movable arc switching electrode and the second connecting pad, said limiter and said disconnector being simultaneously disconnected from the circuit when an electric arc is switched between the first connecting electrode and the second connecting electrode.

5. The device according to claim 1, wherein the voltage surge limiter is electrically connected in series with the disconnecting device by at least one fuse link, drive means exert a displacement force moving the voltage surge limiter in the event of melting of said at least one fuse link, movement of said limiter acting directly on the actuating mechanism to move the third movable arc switching electrode and cause continuous opening of the contacts.

6. The device according to claim 5, wherein the drive means comprise a spring.

7. The device according to claim 5, wherein the voltage surge limiter is electrically connected to the second connecting pad by two fuse links, a first fuse link acting as disconnector against weak short-circuit alternating currents, and a second fuse link melting in case of overheating of said limiter.

8. The device according to claim 7, wherein the second fuse link is a low-temperature weld.

9. The device according to claim 1, wherein the voltage surge limiter comprises a variable resistor.

10. The device according to claim 9, wherein the voltage surge limiter comprises a variable resistor connected in series with a spark gap.

11. The device according to claim 1, wherein a high-energy disconnector is connected in series between the first connecting electrode and the first connecting pad, said high-energy disconnector acting on the actuating mechanism to move the third movable arc switching electrode and cause continuous opening of the contacts.

12. The device according to claim 11, wherein the high-energy disconnector is calibrated to act on the actuating mechanism when electric currents of greater energy than the tripping threshold energy flow through the latter.

13. The device according to claim 11, wherein the high-energy disconnector comprises electromagnetic tripping means.

14. The device according to claim 11, wherein the high-energy disconnector comprises a fuse element.

15. The device according to claim 1, wherein the third movable arc switching electrode is connected to the first connecting electrode by an insulating part forming a spark gap when the electric contacts are closed.

16. The device according to claim 1, wherein the third movable arc switching electrode is in contact with the first connecting electrode when the electric contacts are closed.

17. The device according to claim 16, wherein the disconnector against weak short-circuit alternating currents is disconnected from the circuit when the third movable arc switching electrode moves away from the first connecting electrode and an electric arc is switched between the first connecting electrode and the second connecting electrode.
